(19) United States
(12) Patent Application Publication
(10) Pub. No.: US 2009/0034750 A1
(43) Pub. Date: Feb. 5, 2009

(54) SYSTEM AND METHOD TO EVALUATE AN AUDIO CONFIGURATION

(75) Inventors: RAMY AYOUB, ARLINGTON HEIGHTS, IL (US); GARY LEE CHRISTOPHER, FOX RIVER GROVE, IL (US); BRIAN SIBILSKY, LAKE ZURICH, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/831,579

(22) Filed: Jul. 31, 2007

(51) Int. Cl. H04B 3/00; G06F 17/00; G10L 15/00; G10L 21/00

(52) U.S. Cl. 381/77; 700/94; 704/231; 704/270; 704/E15.001

(57) ABSTRACT

A system (100) and method (300) for evaluating an audio configuration is provided. The system can include a media device (110) that receives audio (121) from an application (115) and transmits the audio, and a media system (150) that receives the audio, and plays the audio out of a speaker (170) to produce external audio (156). The media device can capture the external audio from a microphone (145) to produce captured audio (146), perform pattern matching (125) on the audio signal and the captured audio signal in real-time, and present a notification (200) identifying whether audio sourced by the media device is rendered by the media system.

### FIELD OF THE INVENTION

The exemplary embodiments of the present invention generally relate to systems and methods for audio processing, and more particularly to a system and method to evaluate an audio configuration.

### BACKGROUND

Mobile devices allow users to remain continually connected at home, in the office, and in the car. Moreover, mobile devices are capable of communicating with one another and other systems to broaden the user experience. For instance, a user with a mobile device upon entering a vehicle, can connect the mobile device to the vehicle entertainment system to play audio from the mobile device over the vehicle entertainment system. For example, the mobile device can include a play list of songs that can be played through the vehicle sound system upon being connected to the vehicle entertainment system.

Numerous mobile devices are becoming available for the vehicle, many with lower cost and greater functionality than those products that come integrated in the vehicle. Vehicle owners and drivers are purchasing such products in greater numbers, and will continue to do so in the future. These products are mountable in the vehicle through special car kit adaptors. Many of these after market products and car kit adaptors provide means to integrate the component into the vehicle's entertainment system to enhance the user experience.

In some cases, the communication between the mobile device and the vehicle entertainment system can be automatically performed. In other cases, it may be necessary for the user to manually configure the communication between the mobile device and the vehicle entertainment system. In either case, if the audio system is not properly configured, manually or automatically, the communication between the mobile device and the vehicle entertainment system may not correctly operate. As an example, if the user selects an audio playlist on the mobile device to be played through the vehicle entertainment system, but forgets to properly set the vehicle's entertainment system to receive that audio playlist, then the user may not hear the audio content over the entertainment system. Similarly, if the vehicle entertainment system cannot automatically establish communication with the mobile device, audio content from the mobile device will not be played over the vehicle entertainment system.

As another example, the user may start a navigation application on the mobile device, but not properly set the vehicle entertainment system to receive audio from the mobile device. Because the navigation application may only occasionally present audible navigation messages, the user may not notice that the vehicle entertainment system is not playing the audible navigation messages. This may result in the user missing a turn or other directions from the navigation system.

### SUMMARY

A need therefore arises for evaluating an audio configuration between a media device and a media system.

One embodiment is a system for audibly evaluating an audio configuration. The system can include a media device that receives audio from an application and transmits the audio. A media system communicatively coupled to the media device can receive the audio and play the audio out of a speaker to produce external audio. The media device can capture the external audio from a microphone to produce captured audio, perform pattern matching on the audio signal and the captured audio signal in real-time, and present a notification identifying whether audio sourced by the media device is actually being rendered by the media system. If the audio signal does not match the captured audio signal, the media device can take many actions including routing the audio to an internal speaker for play out, presenting a visual notification on a display that the audio is not being rendered, pause the application providing the audio, and configuring the media system to render the audio, such as setting the media system to an auxiliary mode. The transmitted audio between the media device and media system can be in either digital or analog format.

The media device can transmit the audio via a wired or wireless connection, such as a Bluetooth communication, IEEE 802.xx, a Zig-Bee short-range communication, or a Frequency Modulation (FM) communication. In one arrangement, the media device can use an audio template matching algorithm in a voice recognition engine for performing the audio pattern matching. In another arrangement, the media device can use echo cancellation techniques for performing the audio pattern matching. The media device can be a cell phone, a personal digital assistant, a portable music player, or a navigation kit. The media system can be vehicle entertainment system, a vehicle sound system, a vehicle media system, a home entertainment system, or any entertainment system public use.

A second embodiment is a media device for audibly evaluating an audio configuration of a media system communicatively coupled to the media device. The media device can include a processor for receiving audio from an application, and a communications module for transmitting the audio to the media system. The media system can play the audio out of a speaker to produce external audio. The media device can further include a microphone for capturing the external audio played out of the speaker, and a pattern matching unit to perform pattern matching on the audio signal and the captured audio signal.

If the media device determines that the captured audio signal corresponds to the audio transmitted to the media system, a visual notification identifying whether the media system is rendering the audio transmitted by the media device can be presented on a display of the device. Alternatively, the media device can play the audio through an internal speaker if the pattern matching unit determines that the media system is not rendering the audio transmitted by the media device. The processor can also determine if the media system is actively receiving data from the communications module, and if so, identify a communication protocol associated with the receiving data. If the processor determines that the media system is not receiving data, an indication that communication with the media system is inactive can be presented on the display.

A third embodiment is a method within a media device for audibly evaluating an audio configuration of a media system communicatively coupled to the media device. The method can include the steps of receiving audio from an application, transmitting the audio to the media system, capturing external audio produced from the media system, performing pattern matching on the audio signal and the captured audio signal, and determining if the external audio rendered by the media system corresponds to the audio transmitted by the media device. The method can include presenting a visual notification identifying whether the media system is rendering the audio transmitted by the media device, and/or audibly playing the audio if the media system is not rendering the audio transmitted by the media device. If the media device and the media system are not communicating, instructions can be presented for configuring a communication link between the mobile device and the media system. User configuration settings can be applied to check the audio configuration by using a communication channel to configure the media system to settings for rendering the audio.

In another arrangement, the method can include sending sub-audible test tones to the media system during power up, capturing external sub-audible tones produced by the media system responsive to receiving the sub-audible tones, and presenting a visual notification in response to determining if the external audio rendered by the media system corresponds to the sub-audible test tones based on the pattern matching.

### BRIEF DESCRIPTION OF THE DRAWINGS

The features of the system, which are believed to be novel, are set forth with particularity in the appended claims. The embodiments herein can be understood by reference to the following description, taken in conjunction with the accompanying drawings, in the several figures of which like reference numerals identify like elements, and in which:

FIG. 1 depicts an exemplary system audibly evaluating an audio configuration between a media device and a media system in accordance with an embodiment of the present invention;

FIG. 2 depicts an exemplary visual notification for audio system configuration in accordance with an embodiment of the present invention;

FIG. 3 depicts an exemplary method for audibly evaluating an audio configuration between a media device and a media system in accordance with an embodiment of the present invention;

FIG. 4 is a an exemplary method for audibly evaluating an audio configuration during a power-up in accordance with an embodiment of the present invention; and

FIG. 5 is a block diagram of an electronic device in accordance with an embodiment of the present invention.

### DETAILED DESCRIPTION

Broadly stated, embodiments of the invention are directed to audibly evaluating an audio configuration between a media device and a media system.

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” or “processor” can be defined as any number of suitable processors, controllers, units, or the like that are capable of carrying out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, a source code, an object code, a shared library/dynamic load library and/or other sequence of instructions designed for execution on a computer system.

The term “audio” can be defined as an acoustic, analog, or digital signal comprising audio data. The term “external audio” can be defined as audio produced by a device other than the media device providing the audio. The term “render” can be defined as playing audio in real-time. The term “real-time” can be defined as sufficiently occurring in the present. For example, a real-time pattern matching can compare external audio being played at the moment to audio saved in a memory. The term “sourced” can be defined as providing data. The term “power-up” can be defined as calibrating in response to receiving power, or initializing in response to establishing a communication. The term “sub-audible tone” can be defined as a tone having a frequency level or volume level below a threshold of hearing. The term “audibly” can be defined as within the range of human hearing (e.g. 20 Hz to 20 KHz). The term “audio configuration” can be defined as a manual or automatic selection of parameters or communication settings that allow a media device and a media system to communicate audio messages and signals. The term “speaker” can be defined as a transducer that can produce sound. The term “pattern matching” can be defined as comparing portions of a first audio signal with a second audio signal to determine if they are similar, for example, the same audio content.

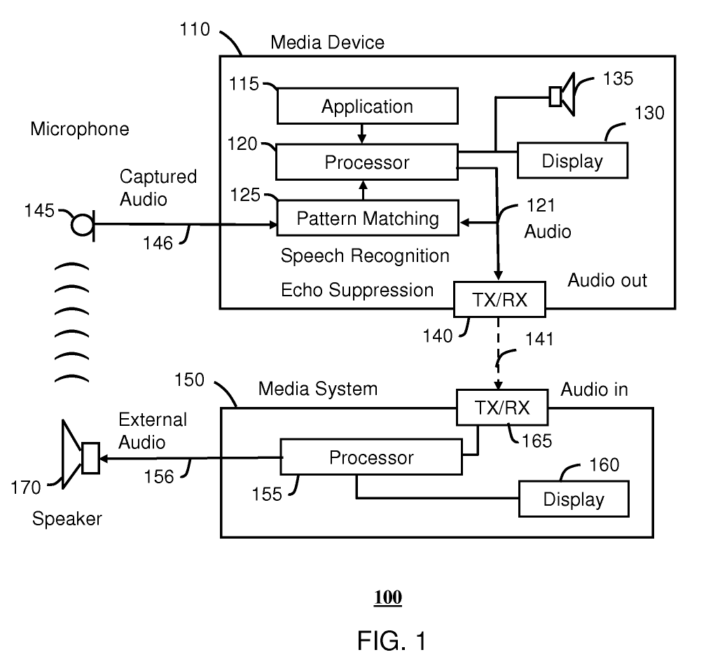

FIG. 1 shows a system 100 for audibly evaluating an audio configuration of a media device 110 and a media system 150. The media device 110 can be a cell phone, portable music player, personal digital assistant, navigation kit, aftermarket device, or any other suitable communication device. The media device 110 can include a processor 120 for receiving directives from at least one application 115, a pattern matching unit 125 operatively coupled to the processor 120, and a communications module 140 operatively coupled to the processor 120 having transmit (TX) and receive (RX) functionalities. The media device 110 can also have a display 130 for presenting visual notifications, an internal speaker 135 for playing audio, and a microphone 145 for capturing external audio, for example, acoustic signals.

The media system 150 can be a vehicle entertainment system, a vehicle sound system, a vehicle media system, a home stereo system, a portable music player, or any other type of audio entertainment system. The media system 150 can include a communications module 165 having transmit (TX) and receive (RX) functionalities for providing wired or wireless communications, and a processor 155 for processing signals received from the communications module 165. The media system 150 can also include a display 160 for presenting visual information, and a speaker 170 for producing external audio. In one arrangement, media system 150 can be temporarily mounted within a vehicle, or permanently included with the vehicle.

As an example, the mobile device 110 can check to see whether audio 121 provided to the media system 150 by the mobile device 110 is being rendered, for instance, in a cabin of a vehicle. If the audio signal 141 received by the media system 150 representing the audio 121 is not being rendered to produce external audio 156, the media device 110 can present a visual indication to the user on the display 130 that the media system 150 needs to be properly set to render the audio in the vehicle. More specifically, the pattern matching unit 125 can compare the captured audio 146, corresponding to the external audio 156, to the audio 121 in real-time to determine if audio sourced by the media device 110 is being rendered in the vehicle. That is, the media device 110 determines if the media system 150 is rendering the audio 121 sourced by the media device. In cases of high priority audio, such as navigation prompts or telephony audio, the media device 110 can automatically route the audio to the internal speaker(s) 135, or route the audio to other auxiliary audio output devices accessible by the media device 110. The pattern matching module 125 can determine if the media system 150 is rendering audio in the cabin. Audio pattern matching techniques can utilize audio template matching algorithms used in VR systems, and/or echo cancellation techniques to determine if the audio being transmitted by the media device 110 is being received by the media system 150 and rendered in the vehicle.

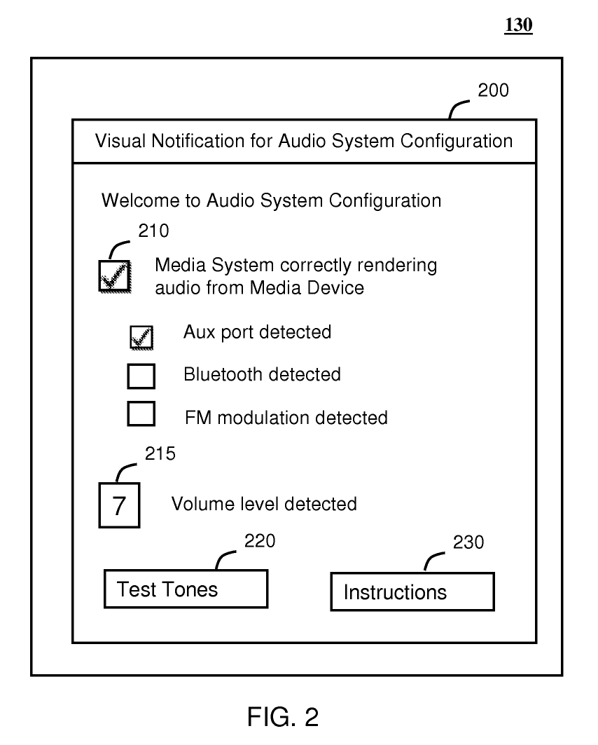

FIG. 2 shows an exemplary visual notification window 200 to provide information related to the evaluation of the audio configuration of the media device 110 and the media system 150. The visual notification window 200 can be presented in either the display 130 of the media device 110, or the display 160 of the media system 150. The communication between the media device 110 and the media system 150 allows for the transport of data, for example, such as packet data over a streaming connection, as well as analog audio.

The visual notification window 200 can present an indication 210, such as a checkbox, that assures the user that the media system 150 is correctly rendering audio from the media device 110. A check is present when the media system 150 correctly renders audio sourced by the media device 110. A check is absent when the media system 150 incorrectly renders audio sourced by the media device 110. The visual notification window 200 can also present the communication link and associated parameter settings identified between the media device 110 and the media system 150. The communication link may be a vehicle bus connection, a direct wired connection, an auxiliary port, a Bluetooth connection (e.g. IEEE 802.x), Zigbee communication protocol, or an FM modulation scheme. The visual notification window 200 can also present a detected volume level 215 in response to the pattern matching.

The visual notification window 200 can also include a test tones button 220 to audibly check the audio configuration between the media device 110 and the media system 150. As an example, the test tones can direct the media device 110 to send sub-audible tones to the media system for rendering. The media device 110 can then proceed to determine if the sub-audible tones are sourced by the media device 110 are rendered by the media system 150. The visual notification window 200 can also include an instructions button 230 to provide help information to the user. The instructions can detect and identify the communication capabilities of the media device 110 and the media system 150 and propose connections for the audio configurations. The instructions may provide visual and audio interactive dialogues to assist the user with the audio configuration. For example, the media device can present instructions for configuring a communication link between the mobile device and the media system, apply user configuration settings received responsive to the step of presenting instructions by using a communication channel to configure the media system to settings for rendering the audio, and checking the audio configuration with the applied user configuration settings.

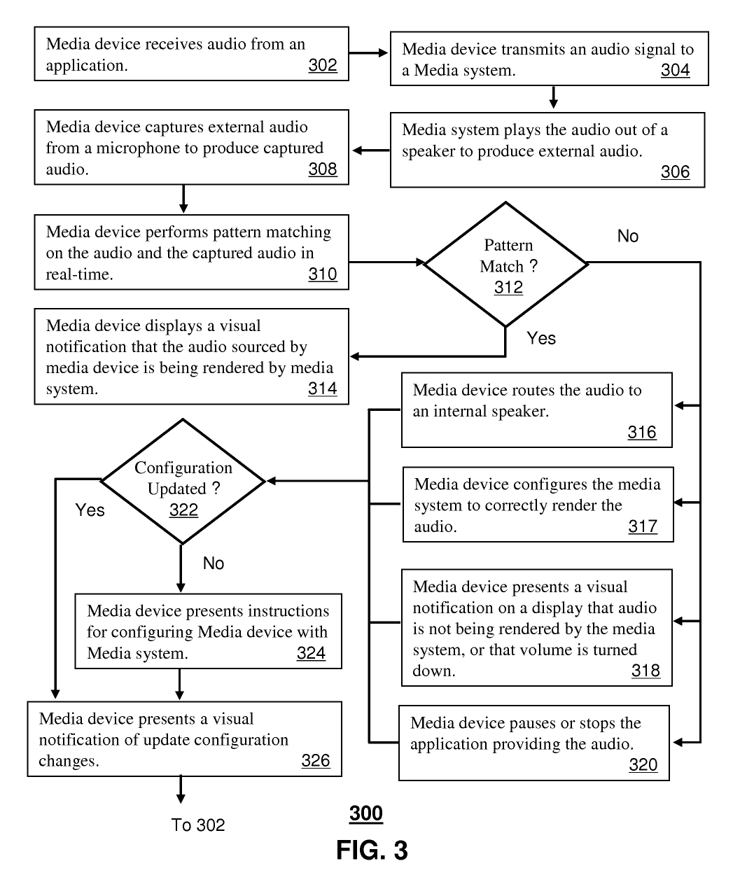

FIG. 3 depicts an exemplary flowchart 300 for audibly evaluating an audio configuration between a media device 110 and a media system 150. When describing the flowchart 300, reference will be made to components of the media device 110 and media system 150 shown in FIG. 1, though it should be noted that the steps can be practiced by other components or devices. It should also be noted that the flowchart can include more or less than the number of method steps shown. Moreover, the flowchart 300 is not limited to the order of the methods steps shown.

The flowchart 300 can start in a state in which a media device 110 and a media system 150 have established a communication. As one example, the communication can be established responsive to the media device 110 detecting a presence of the media system 150, for instance in a peer-to-peer network when the media device 110 enters within a proximity to the media system 150. As another example, the communication can be established responsive to receiving a user directive to connect the media device 110 to the media system 150.

At step 302, the media device 110 receives audio from the application 115. The application 115 can be a software application running on the media device 110, such as a multimedia application, navigation application, or any other audio based program. The application 115 can provide audio to the processor 120 of the media device, for example, from data stored in a memory of the media device 110. In another arrangement, the application 115 can stream or download data over the air using the wireless Radio Frequency (RF) communication capabilities of the media device 110. As yet another example, the application 115 can receive audio (e.g. music, files, voice) from peers within a peer-to-peer network and provide the audio to the processor 120. The application 115 can also provide the audio to the processor 120 in real-time on a continuing basis. For example, the application can stream packets of audio data to the processor 120 at fixed or varying time intervals.

At step 304, the media device 110 transmits an audio signal 141 to the media system 150. The audio signal 141 represents the audio 121 in a compressed format, to provide efficient transmit and receive communication between the media device 110 and the media system 150. If, for example, the audio 121 corresponds to speech data, the compressed format can correspond to vocoded speech. If, for example, the audio 121 corresponds to music data, the compressed format can correspond to MP3 data. The media system 150 upon receiving the audio signal 141 and decompressing the audio signal 141 plays the audio out of the speaker 156 to produce external audio as shown in step 306. It should also be noted that the data can be transmitted in uncompressed format, for example using pulse code modulation format, in a digital format, or also in an analog format such as frequency modulation.

At step 308, the media device 110 captures the external audio produced by the speaker 170 from the microphone 145 to produce captured audio. For example, the processor can direct the microphone 145 at specified times to record the acoustic environment. In such regard, the media device 110 samples the sound in the environment of the media device 110 and media system 150 (e.g., vehicle cabin) to produce the captured audio. In one arrangement, the processor 120 can determine if the captured sound level exceeds a predetermined threshold for a certain period of time, and if so, then proceed to capture the audio for pattern matching purposes. If not, the processor can provide a visual notification 200 (See FIG. 2) that no audible sounds have been identified, with an optional message to increase the media system 150 volume.

While the processor 120 continues to capture external audio from the microphone 145, the media device 110 performs pattern matching on the audio 121 sourced to the media system 150 and the captured audio 146 in real-time as shown in step 310. That is, the pattern matching unit 125 compares the captured audio 146 with the reference audio 121 intended for transmission to the device to determine if the audio is the same. It should be noted that the pattern matching unit 125 can buffer the captured audio 146 as well as temporarily store off the audio 121 during pattern matching. This allows the pattern matching unit 125 to compare audio on a frame by frame basis. Moreover, the pattern matching unit 125 can account for propagation delays associated with acoustic waves traveling from the speaker 170 to the microphone 145. For example, the pattern matching unit 125 can introduce a small delay (e.g., 1-5 ms) to compensate for the propagation delays when comparing the captured audio 146 to the reference audio 121.

As one example, the media device 110 can use template matching in a speech recognition engine for performing the audio pattern matching. For example, the media device 110 may already have a speech recognition system for recognizing speech utterances. Selected portions of speech recognition system can be used to perform the pattern matching of the captured audio 146 and the audio 121. For example, a Dynamic Time Warping (DTW) algorithm can be employed to align the captured audio 146 and the audio 121 and evaluate a pattern similarity. In another example, a Linear Prediction Coefficient (LPC) algorithm can be used to extract features from the audio with a norm metric to calculate a perceived distance, or distortion measure, between frames of the captured audio 146 and the audio 121. In another example, a filterbank analysis within the speech recognition system can be performed to generate features of the audio (e.g. Fast Fourier Transform (FFT)). The speech recognition system can produce a rating that identifies the likeliness, or similarity, of the patterns. The processor 120 can evaluate the rating to determine if the captured audio 141 matches the audio 121 transmitted to the media system 150 by the media device 110.

Alternatively, the media device 110 can use echo cancellation techniques for performing the audio pattern matching. As one example, the media device can use an echo suppressor on the mobile device to evaluate the similarity between sounds captured at the microphone 145 and the audio 121 transmitted to the media system 150. The echo suppressor, which is generally used to suppress echoes created by speaker feedback into a microphone, can be reconfigured as an adaptive filter for pattern matching. In one particular embodiment, the processor 120 can evaluate an error metric of an adaptive Least Mean Squares (LMS) algorithm employed to determine similarities in patterns of the audio. More specifically, the echo suppressor can be configured to suppress the captured audio 146 from the audio 121 to produce the error metric. The error metric can reveal how well the echo suppressor suppresses the captured audio 146. A high error metric can indicate significant differences between frames of the captured audio 146 and the audio 121. A low error metric can indicate similarities between frames of the captured audio 146 and the audio 121. The processor can evaluate the error metric from the echo suppressor to determine if the captured audio 146 corresponds to the audio 121 by interpreting the error criterion as a similarity measure. In such regard, the echo suppressor is reconfigured for use in audio pattern matching.

Returning back to the flowchart 300 of FIG. 3, if at step 312 the patterns match, the media device 110 displays a visual notification that the audio is being rendered as shown in step 314. For example, referring back to FIG. 2, the media device 110 displays a check 210 in the visual notification window 200 to assure the user that the media system 150 is correctly rendering audio from the media device. The visual notification window 200 can also identify the type of communication link between the media device 110 and the media system 150 (e.g., Auxiliary port, Bluetooth, FM modulation). The visual notification window 200 can also indicate a volume level of the captured audio, relative to a predetermined reference level.

If however at step 312 the patterns do not match, the media device 110 can perform one or more mitigating operations. As one example, the media device 110 can route the audio 141 to the internal speaker 135 as shown in step 316. This allows the audio to be rendered in an audible format to the user, since the media system 150 is not identified as rendering the audio 121. As another example, the media device 110 can present a visual notification that the audio is not being rendered, or that volume is turned down, as shown in step 318. Referring back to FIG. 2, the visual notification window 200 may present an “x” in the checkbox 210 to indicate that the media system is not correctly rendering audio from the media device 110. Returning back to FIG. 3, in yet another example, the media device 110 can pause or stop the application 115 providing the audio 121 as shown in step 320. The visual notification 200 (See FIG. 2) can also be presented to inform the user that the application has been stopped or paused. In systems where there is data communications between the media device and media system, the media device may also configure 317 the media system to correctly render the audio. For example, a vehicle bus message to put the media system in “aux” mode may be sent to the media system to ensure the audio will be rendered.

As previously noted, the visual notification window 200 can present instructions 230 for providing visual and/or auditory information to the user for configuring the audio between the media device 110 and the media system 150. After performing the one or more mitigating operations 316-320, the visual notification window 200 can be presented with the instructions 230 in an interactive help format. This allows the user to manually select or modify the audio configuration settings. If the media device 110 detects that the configuration changes have not been updated, the visual notification window 200 can present further instructions for configuring the media device 110 with the media system 150. Upon the media device 110 at step 322 determining that the configuration has been updated, the media device presents a visual notification of the user configuration changes at step 324. A communication channel can be used to configure the media system to corresponding settings for rendering the audio The visual notification window 200 can associate and save the audio configuration settings for the media device 110. The media device 110 may also audibly present a “successful configuration audio clip” via the internal speaker 135 to audibly confirm the updated configuration. The method can return to step 302 to again audibly evaluate the audio configuration between the media device 110 and the media system 150.

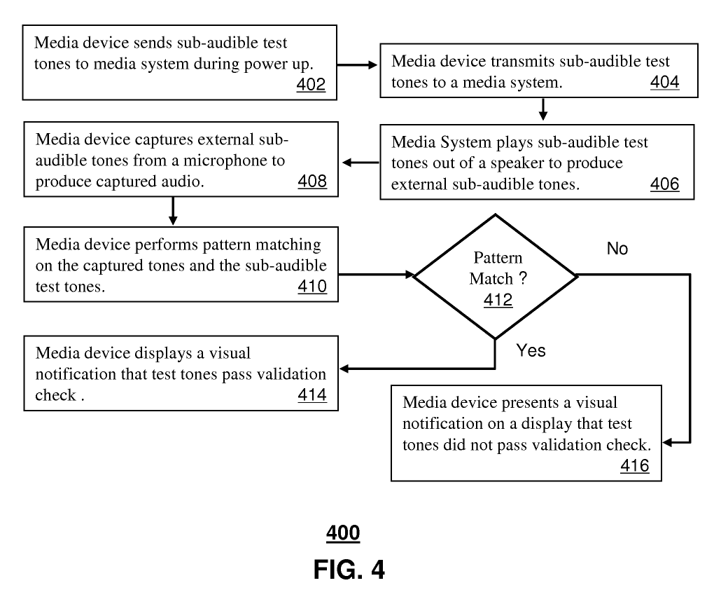

Referring to FIG. 4, a flowchart 400 for inaudibly evaluating the audio configuration between the media device 110 and the media system 150 is shown. When describing the flowchart 400, reference will be made to components of the media device 110 and media system 150 shown in FIG. 1. It should also be noted that the flowchart 400 can include more or less than the number of method steps shown. Moreover, the flowchart 400 is not limited to the order of the methods steps shown.

Briefly, sub-audible tones are generated to determine if the media system 150 is rendering audio received from the media device 110. In such regard, the evaluating of the audio configuration is not perceivable by the user (i.e., inaudible) as a result of the sub-audible tones.

The flowchart 400 can start at step 402 in which the media device 110 sends sub-audible test tones to the media system 150 during power-up. Power-up can occur when the media device 110 or the media system 150 is powered on, possibly during a calibration mode. Power-up can also occur when the media device 110 detects a presence of the media system 150, for example, when the media device 110 enters close proximity to the media system 150. This procedure can also be executed during system installation and setup.

At step 404, the media device 110 transmits sub-audible test tones to the media system 150. The sub-audible test tones can be transmitted as an audio signal 141 in compressed format to the media system 150. Upon receiving, the audio signal 141 and decoding the audio signal 141, the media system plays the sub-audible test tones out of the speaker 170 to produce external sub-audible tones as shown in step 406. Although, the sub-audible tones produce acoustic waves, the sounds of the sub-audible tones are below a threshold of human hearing and are inaudible to humans. At step 408, the media device 110 captures the external sub-audible tones from the microphone 145 and produces captured audio 146. The pattern matching unit 125 of the media device 110 then proceeds to perform pattern matching on the captured tones and the sub-audible test tones at step 410. As previously noted, the pattern matching unit can use template matching from in a speech recognition engine to evaluate the similarity of the patterns. Alternatively, the pattern matching unit can use echo cancellation techniques for performing the audio pattern matching.

If at step 412 the patterns match, the media device 110 displays a visual notification that the test tones passed the validation check as shown in step 414. If however at step 412 the patterns do not match, the media device 110 presents a visual notification that the test tones did not pass the validation check at step 416. In either case, the visual notification informs the user to the status of the audio configuration between the media device 110 and the media system 150 as either an active connection or inactive connection. In particular, the visual notification identifies whether audio sourced by the media device 110 is rendered by the media system 150. Referring back to FIG. 2, the user can then refer to the instructions or an automated help facility to manually or automatically establish the audio configuration between the two devices.

From the foregoing descriptions, it would be evident to an artisan with ordinary skill in the art that the aforementioned embodiments can be modified, reduced, or enhanced without departing from the scope and spirit of the claims described below. For example, some or a portion of the processing described for flowchart 300 can be redistributed at different portions of the system 100. For instance, the media system 150 instead of the media device 100 can perform the pattern matching to conserve battery power of the mobile device. Moreover, the media system 150 may initiate audibly evaluating the audio configuration, by determining if the media device 100 is sourcing data, and itself determine if it is correctly rendering audio. Also, the media device may provide a report summary for the audio configurations on different media systems 150. The supplemental embodiments of flowchart 400 can further be removed or modified without adversely affecting operations of the present disclosure. These are but a few examples of how the embodiments described herein can be updated without altering the scope of the claims below. Accordingly, the reader is directed to the claims for a fuller understanding of the breadth and scope of the present disclosure.

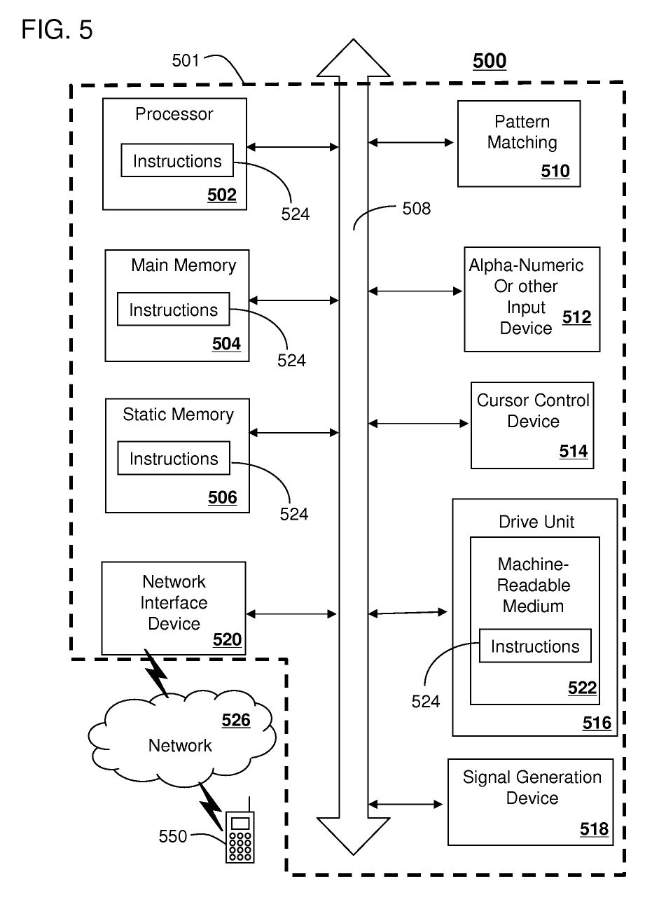

In another embodiment of the present invention as illustrated in the diagrammatic representation of FIG. 5, the media device 110 can be represented as a machine (e.g., a portable music player, a cellular phone, a laptop, a PDA, etc.). The machine can include a controller 502 coupled to the pattern matching unit 510. Generally, in various embodiments the media device 110 can be thought of as a machine in the form of a computer system 500 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 501 and a sending device 550 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 500 can include a controller or processor 502 (e.g., a central processing unit (CPU), a graphics processing unit (GPU), or both), a main memory 504 and a static memory 506, which communicate with each other via a bus 508. The computer system 500 may further include a presentation device such the flexible display 510. The computer system 500 can include an input device 512 (e.g., a keyboard, microphone, etc) a cursor control device 514 (e.g., a mouse, touchpad, touchscreen), a disk drive unit 516, a signal generation device 518 (e.g., a speaker or remote control that can also serve as a presentation device) and a network interface device 520. Of course, in the embodiments disclosed, many of these items are optional.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor or controller 502 during execution thereof by the computer system 500. The main memory 504 and the processor or controller 502 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A system for audibly evaluating an audio configuration, the system comprising:
a media device that receives audio from an application and transmits the audio; and
a media system communicatively coupled to the media device that receives the audio, and plays the audio out of a speaker to produce external audio,
wherein the media device captures the external audio from a microphone to produce captured audio, performs pattern matching between the transmitted audio signal and the captured audio signal in real-time, and determines whether the transmitted audio signal is being rendered by the media system
where the transmitted audio between the media device and media system is either digital or analog audio.

2. The system of claim 1, wherein the media device uses template matching in a speech recognition engine for performing the audio pattern matching.

3. The system of claim 1, wherein the media device uses echo cancellation techniques for performing the audio pattern matching.

4. The system of claim 1, wherein the media device is one among a cell phone, a personal digital assistant, a portable music player, and a navigation kit.

5. The system of claim 1, wherein the media system is one among a vehicle entertainment system, a vehicle sound system, a vehicle media system, or an entertainment system for home or public use.

6. The system of claim 1, wherein the media device transmits the audio via a wired or wireless connection.

7. The system of claim 6, wherein the wireless connection is one among a Bluetooth communication, a Zig-Bee short-range communication, and a Frequency Modulation (FM) communication.

8. The system of claim 1, wherein the media device routes audio to an internal speaker if the captured audio does not match the audio sourced by the media device.

9. The system of claim 1, wherein the media device presents a visual notification on a display that audio is not being rendered if the captured audio does not match the audio sourced by the media device, and configures the media system to the correct settings to render the audio

10. The system of claim 1, wherein the media device pauses or stops the application providing the audio if the captured audio does not match the audio sourced by the media device.

11. A media device for evaluating an audio configuration of a media system communicatively coupled to the media device, the media device comprising:
a processor for receiving audio from an application;
a communications module for transmitting the audio to the media system;
a microphone for capturing external audio played out by the media system; and
a pattern matching unit to perform pattern matching on the captured audio and the audio sourced by the media device to determine if the captured audio corresponds to the audio sourced to the media system.

12. The media device of claim 11, further comprising
a display for presenting a visual notification identifying whether audio sourced by the media device is rendered by the media system

13. The media device of claim 11, further comprising
an internal speaker for playing the audio if the pattern matching unit determines that the media system is not rendering the audio transmitted by the media device.

14. The media device of claim 11, wherein the processor determines if the media system is actively receiving data from the communications module, and if so, identifies a communication protocol associated with the receiving data, and if not, presents an indication that communication with the media system is inactive.

15. The media device of claim 11, wherein the media device is one among a cell phone, a personal digital assistant, a portable music player, and a navigation kit, and the media system is one among a vehicle entertainment system, a vehicle sound system, a vehicle media system, or any entertainment system for home or public use.

16. A method within a media device for evaluating an audio configuration of a media system communicatively coupled to the media device, the method comprising the steps of:
receiving audio from an application;
transmitting the audio to the media system;
capturing external audio produced from the media system;
performing pattern matching on the audio signal and the captured audio signal; and
determining if the external audio rendered by the media system corresponds to the audio sourced by the media device based on the pattern matching.

17. The method of claim 16, further comprising
presenting a visual notification identifying whether the media system is rendering the audio sourced by the media device

18. The method of claim 16, further comprising
audibly playing the audio if the media system is not rendering the audio transmitted by the media device.

19. The method of claim 17, further comprising
presenting instructions for configuring a communication link between the mobile device and the media system;
applying user configuration settings received responsive to the step of presenting instructions by using a communication channel to configure the media system to settings for rendering the audio; and
checking the audio configuration with the applied user configuration settings.

20. The method of claim 16, further comprising:
sending sub-audible test tones to the media system during power up;
capturing external sub-audible tones produced by the media system responsive to receiving the sub-audible tones; and
presenting a visual notification in response to determining if the external audio rendered by the media system corresponds to the sub-audible test tones based on the pattern matching.
